(19) United States
(12) Patent Application Publication
(10) Pub. No.: US 2009/0323351 A1
(43) Pub. Date: Dec. 31, 2009

(54) Lamp Structure

(76) Inventors: Che-Kai Chen, Shulin City (TW); Yao-Hung Wong, Kaohsiung City (TW); Sam Wu, Sunnybank (AU)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/164,191

(22) Filed: Jun. 30, 2008

(51) Int. Cl. F21V 7/00

(52) U.S. Cl. 362/310

(57) ABSTRACT

A lamp structure provided comprises: a slim light emitting source including at least one LED packaged on a multilayered printed circuit board type aluminum base; a funnel-shaped reflector being concaved toward a center thereof and defined with at least one hole for partially accommodating the LED, and an inner surface of the reflector being coated to form a light reflecting surface; a flat lens whose surface being treated with sand blast; a lamp housing with a receiving chamber for accommodation of the slim light emitting source, the reflector, the flat lens, and a driver, the lamp housing being formed with a plurality of heat dissipation fins; and the driver inserted in the other end of the receiving chamber of the lamp and having a positive and negative leads connected to the slim light emitting source for enabling it to produce light.

### BACKGROUND OF THE INVENTION

1. Field of the Invention

The present invention relates to a lamp structure, and more particularly to a lamp structure with focused bright light, its illumination angle is as large as 180 degrees, and the lamp has a long life, good heat dissipation and is environmental friendly.

2. Description of the Prior Art

Conventional lights, not matter wall or ceiling type, are all big in size and occupy a lot space. On top of that, if the light itself doesn't have an appealing appearance and a well-designed shape, it can't be in harmony with the surrounding decorations.

The present invention has arisen to mitigate and/or obviate the afore-described disadvantages.

### SUMMARY OF THE INVENTION

The primary objective of the present invention is to provide a lamp structure with focused bright light, its illumination angle is as large as 180 degrees, and the lamp has a long life, good heat dissipation and is environmental friendly.

To achieve the above objective, the lamp structure provided in accordance with the present invention comprises:

a slim light emitting source including at least one light emitting diode packaged on a multilayered printed circuit board type aluminum base;

a funnel-shaped reflector being concaved toward a center thereof, in a bottom of the reflector being defined at least one hole for partially accommodating a surface of the light emitting diode, and an inner surface of the reflector being coated to form a light reflecting surface;

a flat lens whose surface being treated with sand blast;

a lamp housing including a receiving chamber, one end of which being accommodated with the slim light emitting source, the reflector, and the flat lens, respectively, and the other end of which being provided for insertion of a driver, an outer surface of the lamp housing being formed with a plurality of heat dissipation fins; and

the driver being inserted in the other end of the receiving chamber of the lamp and having a positive and negative leads connected to the slim light emitting source for making it produce light.

The light emitting diode is any color and is high power.

### BRIEF DESCRIPTION OF THE DRAWINGS

FIG. 1 is an exploded view of a lamp structure in accordance with a preferred embodiment of the present invention;

FIG. 2 is a perspective view of the lamp structure in accordance with the preferred embodiment of the present invention;

FIG. 3 is a cross sectional view of the lamp structure in accordance with the preferred embodiment of the present invention; and

FIG. 4 is another cross sectional view of the lamp structure in accordance with the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

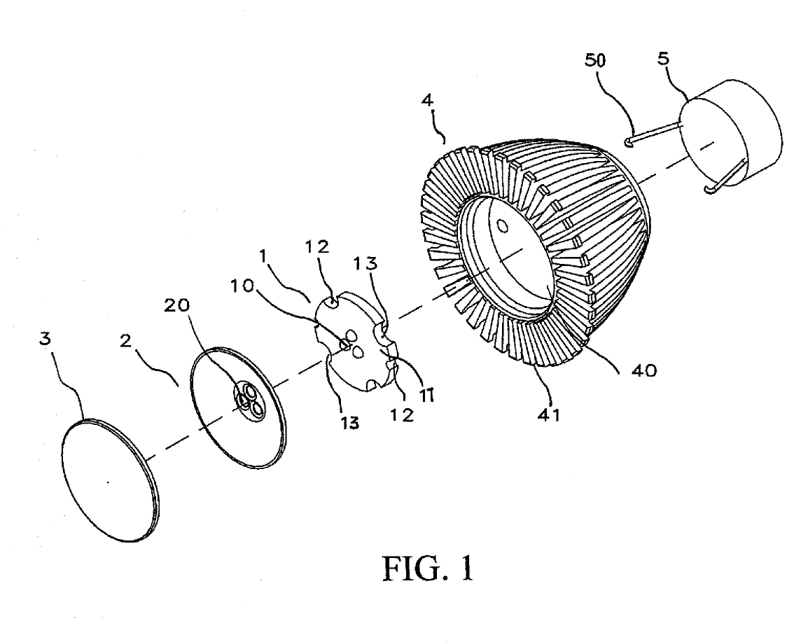

Referring to FIG. 1, which is an exploded view of a lamp structure in accordance with a preferred embodiment of the present invention. The lamp structure comprises: a slim light emitting source 1, a reflector 2, a flat lens 3, a lamp housing 4 and a driver 5.

The light emitting source 1 includes one or more high power LED (light emitting diode) 10 packaged on a MPCB (multilayered printed circuit board) aluminum base 11, and the LED 10 can be any color. Around the periphery of the aluminum base 11 are oppositely arranged two locking grooves 12 for passage and electrical connection of the positive and negative leads 50 of the driver 5 and a plurality of gaps 13 for making it easier to take out the light emitting source I from the lamp housing 4 when replacement is required.

The reflector 2 is funnel-shaped and concaved toward the center thereof, in the bottom of the reflector 2 are defined one or more holes 20 for accommodation of a part of the surface of the LED 10, and the inner surface of the reflector 2 is coated to form a light reflecting surface for adjusting the illumination angle, eliminating shade, and focusing the light generated from the light source while preventing waste of light.

The surface of the flat lens 3 is treated with sand blast to blend the light source and carry out luminous reflectance, so that the illumination angle can be adjusted up to 180 degrees, ghosting is prevented, and the light source is emitted out in a focused way.

The lamp housing 4 includes a receiving chamber 40, one end of which is accommodated with the slim light emitting source 1, the reflector 2, and the flat lens 13, respectively, and the other end of which is provided for insertion of the driver 50. The outer surface of the lamp housing 4 is formed with a plurality of heat dissipation fins 41.

The driver 5 is inserted in the other end of the lamp 4 and has positive and negative leads 50 connected to the slim light emitting source 1 for making it to produce light.

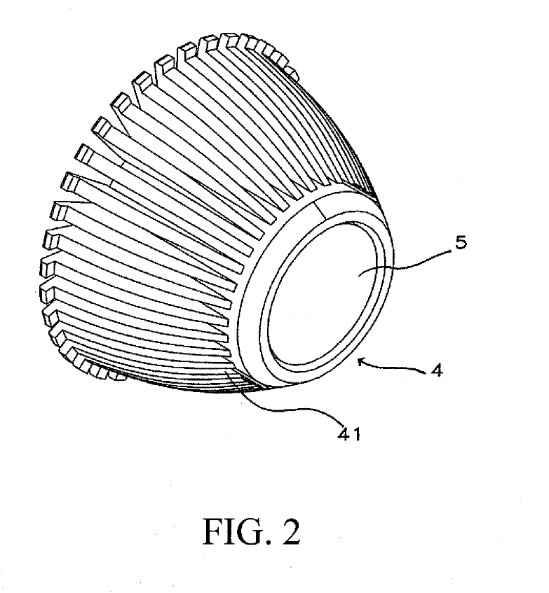

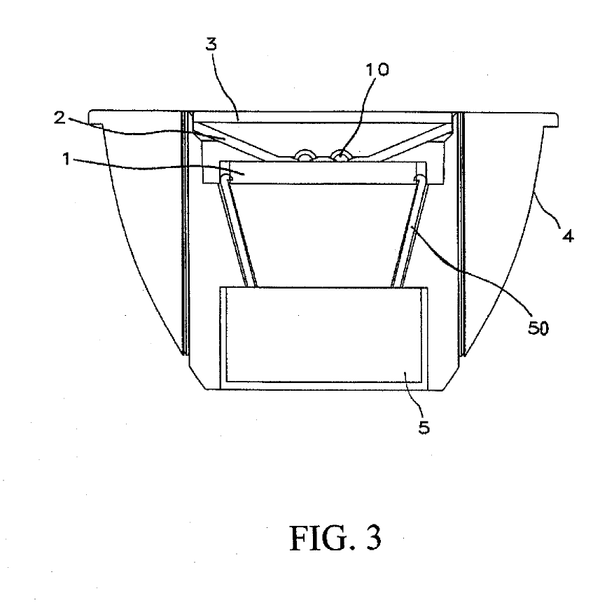

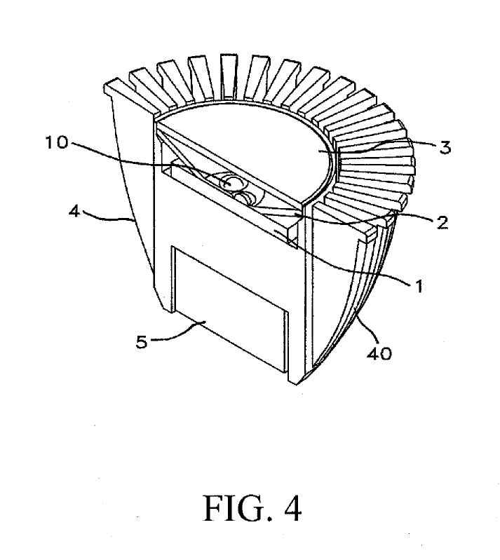

As shown in FIG. 2, which is a perspective view of a lamp structure in accordance with the preferred embodiment of the present invention, the light emitting source 1 is inserted in the receiving chamber 40 of the lamp housing 4, and then the reflector 2 is inserted with its holes 20 aligned and engaged with the LEDs 10. After that, the flat lens 3 is assembled, and then the driver 5 is inserted into the other end of the receiving chamber 40 with its positive and negative leads extending into electrical contact with the light emitting source 1, as shown in FIGS. 3 and 4, thus forming a lamp.

When in use, the operating voltage of the lamp is 12 V, and because of the high power LEDs 10, the light emitting source 1 will produce bright enough light and has a long life. On top of that, the reflector 2 can adjust the illumination angle of the LEDs 10, illuminate shade, and focus the light of the light emitting source. Furthermore, the sand blasted flat lens 3 can blend the light emitting source to have an illumination angle of 180 degrees, and thus ghosting is prevented. Finally, the fins 41 around the outer periphery of the lamp housing 4 can effectively improve the heat dissipation efficiency.

While we have shown and described various embodiments in accordance with the present invention, it is clear to those skilled in the art that further embodiments may be made without departing from the scope of the present invention.

What is claimed is:

1. A lamp structure comprising:
a slim light emitting source including at least one light emitting diode packaged on a multilayered printed circuit board type aluminum base;
a funnel-shaped reflector being concaved toward a center thereof, in a bottom of the reflector being defined at least one hole for partially accommodating a surface of the light emitting diode, and an inner surface of the reflector being coated to form a light reflecting surface;
a flat lens whose surface being treated with sand blast;
a lamp housing including a receiving chamber, one end of which being accommodated with the slim light emitting source, the reflector, and the flat lens, respectively, and the other end of which being provided for insertion of a driver, an outer surface of the lamp housing being formed with a plurality of heat dissipation fins; and
the driver being inserted in the other end of the receiving chamber of the lamp and having a positive and negative leads connected to the slim light emitting source for enabling it to produce light.

2. The lamp structure as claimed in claim 1, wherein the aluminum base is provided around its periphery thereof with two oppositely arranged locking grooves for passage and electrical connection of the positive and negative leads, and a plurality of gaps for making it easier to take out the light emitting source from the lamp housing when replacement is required.

3. The lamp structure as claimed in claim 1, wherein the light emitting diode is any color.

4. The lamp structure as claimed in claim 1, wherein the light emitting diode is high power.
